(19) United States
(12) Patent Application Publication
(10) Pub. No.: US 2004/0207912 A1
(43) Pub. Date: Oct. 21, 2004

(54) Method and apparatus for distributing pump energy to an optical amplifier array in an asymmetric manner

(76) Inventors: Jonathan A. Nagel, Brooklyn, NY (US); Mark K. Young, Monmouth Junction, NJ (US); David S. DeVincentis, Flanders, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/417,657

(22) Filed: Apr. 17, 2003

(51) Int. Cl. H01S 3/00

(52) U.S. Cl. 359/341.3

(57) ABSTRACT

An optical repeater includes a plurality of optical amplifiers and a plurality of pump sources for providing pump energy to the plurality of optical amplifiers. The optical repeater also includes a coupling arrangement coupling the pump energy from the plurality of pump sources to the plurality of optical amplifiers so that the pump energy from each pump source is distributed among at least two of the plurality of optical amplifiers in a substantially unequal manner.

### FIELD OF THE INVENTION

The present invention relates generally to optical amplifiers such as employed in optical transmission systems, and more particularly to an optical amplifier arrangement in which a failed pump source can be readily determined.

### BACKGROUND OF THE INVENTION

Optical amplifiers have become an essential component in optical transmission systems and networks to compensate for system losses, particularly in wavelength division multiplexed (WDM) and dense wavelength division multiplexed (DWDM) communication systems. In a WDM transmission system, two or more optical data carrying channels, each defined by a different carrier wavelength, are combined onto a common path for transmission to a remote receiver. The carrier wavelengths are sufficiently separated so that they do not overlap in the frequency domain. Typically, in a long-haul optical fiber system, an optical amplifier would amplify the set of wavelength channels simultaneously, usually after traversing distances less than about 120 km.

One class of optical amplifiers is rare-earth doped optical amplifiers, which use rare-earth ions as the active element. The ions are doped in the fiber core and pumped optically to provide gain. The silica fiber core serves as the host medium for the ions. While many different rare-earth ions such as neodymium, praseodymium, ytterbium etc. can be used to provide gain in different portions of the spectrum, erbium-doped fiber amplifiers (EDFAs) have proven to be particularly attractive because they are operable in the spectral region where optical loss in the fiber is minimal. Also, the erbium-doped fiber amplifier is particularly useful because of its ability to amplify multiple wavelength channels without crosstalk penalty, even when operating deep in gain compression. EDFAs are also attractive because they are fiber devices and thus can be easily connected to telecommunications fiber with low loss.

An important consideration in the design of a WDM transmission system is reliability, particularly when the system is not readily accessible for repair, such as in undersea applications. Since the laser pump is the only active component in the amplification system, it is the most likely to degrade or fail. Such failure would render the optical amplifier, and possibly the optical communication system, inoperative. In order to overcome such an event, several techniques have been developed to design optical communication systems capable of limiting the impact of laser pump failure or degradation. For example, redundancy is sometimes used to obviate optical amplifier failures.

Redundancy can be conveniently employed when two or more optical amplifiers are employed in a single location, which is often the case in a typical long-range optical transmission system that includes a pair of unidirectional optical fibers that support optical signals traveling in opposite directions. In such systems each fiber includes an optical amplifier, which are co-located in a common housing known as a repeater. When multiple amplifiers are co-located redundancy can be achieved by sharing pump energy form all the available pumps among all the amplifiers. For example, in U.S. Pat. No. 5,173,957, the output from at least two pump sources are coupled via a 3 dB optical coupler to provide pump energy to each of two optical fiber amplifiers simultaneously. If one of the pump sources fails, the other pump source provides power to each of the optical amplifiers. Thus, failure of one laser pump causes a 50% reduction in the pumping power of each of the two optical amplifiers. Without such pump sharing, a pump failure could lead to catastrophic failure in one amplifier and no failures in the other. As long as some pump energy reaches each amplifier, there will be enough gain to convey the signals to the next optical amplifier. On the other hand, if any given amplifier were to lose all its pump energy, it becomes a lossy medium and attenuates the signals, usually leading to excessive signal-to-noise ratio at the end of the systems.

Unfortunately, pump redundancy alone is not sufficient to provide the highest reliability since there is no provision for identifying which pump has failed.

### SUMMARY OF THE INVENTION

In accordance with the present invention, an optical repeater is provided. The optical repeater includes a plurality of optical amplifiers and a plurality of pump sources for providing pump energy to the plurality of optical amplifiers. The optical repeater also includes a coupling arrangement coupling the pump energy from the plurality of pump sources to the plurality of optical amplifiers so that the pump energy from each pump source is distributed among at least two of the plurality of optical amplifiers in a substantially unequal manner.

In accordance with one aspect of the invention, the coupling arrangement comprises a plurality of input ports respectively coupled to the plurality of pump sources and a plurality of output ports respectively coupled to the optical amplifiers. The coupling arrangement is characterized by a coupling ratio that includes at least two different values for optical paths located between a given one of the input ports and at least two of the output ports.

In accordance with another aspect of the invention, the coupling arrangement comprises a plurality of input ports respectively coupled to the plurality of pump sources and a plurality of output ports respectively coupled to the optical amplifiers. The coupling arrangement is characterized by a coupling ratio that includes at least two different values for optical paths located between each of the plurality of input ports and at least two of the output ports.

In accordance with another aspect of the invention, the coupling arrangement comprises a plurality of input ports respectively coupled to the plurality of pump sources and a plurality of output ports respectively coupled to the optical amplifiers. The coupling arrangement is characterized by a coupling ratio that gives rise to a unique pattern in gain change of the optical amplifiers upon failure of a particular one of the plurality of pump sources.

In accordance with another aspect of the invention, the coupling arrangement comprises a plurality of input ports respectively coupled to the plurality of pump sources and a plurality of output ports respectively coupled to the optical amplifiers. The coupling arrangement is characterized by a coupling ratio between a first of the input ports and a first of the output ports that is greater than the coupling ratio between the first input port and all remaining output ports.

In accordance with another aspect of the invention, the coupling arrangement is further characterized by a coupling ratio between a second of the input ports and a second of the plurality of output ports that is greater than the coupling ratio between the second input port and all remaining output ports.

In accordance with another aspect of the invention, the optical amplifiers are rare-earth doped optical amplifiers such as erbium-doped optical amplifiers.

In accordance with another aspect of the invention, the coupling arrangement is a fused fiber coupler.

In accordance with another aspect of the invention, the plurality of optical amplifiers comprises four optical amplifiers, the plurality of pump sources comprise four pump sources, and the coupling arrangement is a 4×4 coupler.

In accordance with another aspect of the invention, an optical amplifier arrangement is provided. The optical amplifier arrangement comprises a plurality of rare-earth doped fibers each coupled to a different optical transmission path and a plurality of pump sources for providing pump energy to the plurality of rare-earth doped fibers. A coupling arrangement coupling the pump energy from the plurality of pump sources to the plurality of rare-earth doped fibers so that the pump energy from each pump source is distributed among at least two of the plurality of rare-earth doped fibers in a substantially unequal manner.

In accordance with another aspect of the invention, a method of distributing pump energy among a plurality of optical amplifiers is provided. The method begins by receiving pump energy from a plurality of pump sources. The pump energy from the plurality of pump sources is distributed to the plurality of optical amplifiers so that the pump energy from each pump source is provided in unequal amounts among at least two of the plurality of optical amplifiers.

In accordance with another aspect of the invention, a method is provided for identifying a failure of a particular pump source from among a plurality of pump sources that collectively supply pump energy to a plurality of optical amplifiers. The method begins by monitoring a change in an output parameter from each of the plurality of optical amplifiers. Upon failure of a particular one of the plurality of pump sources, a change is identified in the output parameter from each of the plurality of optical amplifiers. Based on the change in the output parameter from each of the plurality of optical amplifiers, the particular one of the plurality of pump sources that has failed is identified.

In accordance with another aspect of the invention, the output parameter is amplifier gain or optical output power.

### BRIEF DESCRIPTION OF THE DRAWINGS

FIG. 1 shows an arrangement for supplying pump energy to an optical amplifier located in each of four unidirectional optical fiber paths constructed in accordance with the present invention.

FIG. 2 shows a graph that may be used to determine optimal or near optimal values for the coupling ratios of the coupler employed in the present invention.

### DETAILED DESCRIPTION

The present inventors have recognized that a pump sharing technique can be employed that provides both redundancy and the capability to identify the particular pump or pumps that have failed. This cannot be achieved with the conventional pump sharing technique discussed above because all the pump energy from each pump is equally distributed among all the amplifiers so that the failure of any particular pump will affect all the amplifiers equally. Since all the amplifiers behave the same when a pump fails, there is no mechanism for determining which pump has failed. In the present invention, pump energy is distributed among the amplifiers in an asymmetric or unequal manner so that the failure of a given pump gives rise to a unique pattern of amplifier behavior. The pump energy is distributed asymmetrically by using an asymmetric coupler located between the pump sources and the doped fibers employed in the amplifiers.

Of course, the present invention requires an arrangement for monitoring the gain of the optical amplifiers. Such an arrangement is often already available in optical transmission systems. In general, the amplifier gain may be determined by any amplifier gain monitoring means available to those of ordinary skill in the art such as a COTDR arrangement, for example.

For purposes of illustration only the present invention will be described in connection with a four-fiber transmission path that receives pump energy from four pump sources. However, the present invention is not limited to such an arrangement. More generally, the present invention is applicable to a transmission path that employs N optical amplifiers located in N transmission paths and M pump sources, where N and M are integers equal to or greater than two.

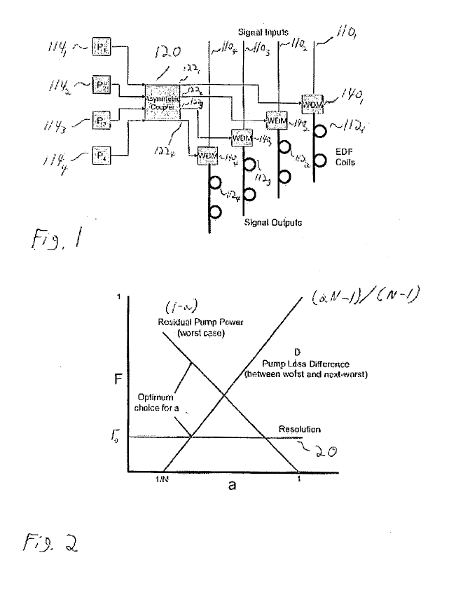

FIG. 1 shows four unidirectional optical fiber paths 110₁, 110₂, 110₃, and 110₄ that each include a rare-earth doped fiber 112₁, 112₂, 112₃, and 112₄, respectively, for imparting gain to the optical signals traveling along the fiber paths. In a transmission system the fiber paths 110₁, 110₂, 110₃, and 110₄ may be arranged in two pairs, each of which support bi-directional communication. Four pump sources 114₁, 114₂, 114₃, and 114₄ supply pump energy to the rare-earth doped fibers 112₁, 112₂, 112₃, and 112₄. A 4×4 asymmetric coupler 120 combines the pump energy generated by the pump sources 114₁, 114₂, 114₃, and 114₄ and splits the combined power among the rare-earth doped fibers 112₁, 112₂, 112₃, and 112₄. Coupling elements 140₁, 140₂, 140₃, and 140₄ respectively receive the pump energy from the output ports 122₁, 122₂, 122₃, and 122₄ of the asymmetric coupler 120 and respectively direct the pump energy onto the fiber paths 110₁, 110₂, 110₃, and 110₄, where the pump energy is combined with the signals. The coupling elements 140₁, 140₂, 140₃, and 140₄, which may be fused fiber couplers or wavelength division multiplexers, for example, are generally configured to have a high coupling ratio at the pump energy wavelength and a low coupling ratio at the signal wavelength. The pump energy provided to the rare-earth doped fibers 112₁, 112₂, 112₃, and 112₄ is proportional to their gain or output power.

Asymmetric coupler 120 distributes an unequal amount of pump energy from each of the pump sources to the rare-earth doped fibers 112₁, 112₂, 112₃, and 112₄. Because the pump energy is proportional to amplifier gain, the distribution of pump energy is preferably selected so that the failure of any particular pump (or combination of pumps) will give rise to a unique set of values in the gain imparted to the signals by the rare-earth doped fiber 112₁, 112₂, 112₃, and 112₄. That is, for each pump that fails, the amplifier gains collectively change in a way that constitutes a unique pattern or signature that can be used to identify the failed pump. The distribution of pump energy is determined by the coupling ratios between the input and output ports of the asymmetric coupler 120. While the coupling ratios can have any values that satisfy the aforementioned criterion for distributing pump energy, some general considerations will be provided to facilitate their selection and to better illustrate the principals of the invention.

By way of example, assume that the coupling ratios between input ports i and output ports j of asymmetric coupler 120 have a greater value when i=j than when i≠j. That is, the pump energy supplied from pump source 114₁ to doped fiber 112₁ is greater than that supplied from pump source 114₁ to each of the doped fibers 112₂, 112₃, and 112₄. Likewise, the pump energy supplied from pump source 114₂ to doped fiber 112₂ is greater than that supplied from pump source 114₂ to each of the doped fibers 112₁, 112₃, and 112₄. The pump energy supplied from pump sources 114₃ and 114₄ is distributed in a similar manner. Now, assume that pump source 114₁ fails. Since coupler 120 supplies a disproportionate amount of the energy from pump source 114₁ to doped fiber 112₁, as a result of the failure the gain imparted by doped fiber 112₁ will decrease more than the gain imparted by doped fibers 112₂, 112₃, and 112₄. Accordingly, by monitoring the gain arising from each of the doped fibers 112₁, 112₂, 112₃, and 112₄, the change in gain can be used to identify the particular pump that has failed. In a similar manner, if pump source 114₂ fails instead of pump source 114₁, the change in the gain of doped fiber 112₂ will be greater than the gain change of doped fibers 112₁, 112₃, and 112₄.

In more analytic terms, assume that the asymmetric coupler 120 is characterized by the coupling ratio aᵢⱼ, where the first index corresponds to the input port and the second index to the output port of the coupler 120. Conservation of energy requires that

$${\sum }_{j = 1}^{N} {a}_{ij} = 1$$

where N is the number of input and output ports of the asymmetric coupler 120, and which in FIG. 1, is equal to 4.

For a symmetric coupler, i.e., a coupler that evenly divides the power among the output ports, aᵢⱼ=1/N. In contrast, the asymmetric coupler 120 employed in the present invention has values for the coupling ratio aᵢⱼ that are selected to distribute power among the doped fibers so that the pump energy from each pump source is distributed among at least two of the plurality of optical amplifiers in a substantially unequal manner.

Two criteria may be considered in determining optimal or near optimal values of the coupling ratios aᵢⱼ:

1. After a single pump failure, the remaining pump energy should be distributed so that the minimum pump energy supplied to any of the doped fibers is maximized. This criterion maintains the highest level of amplifier performance after the failure of a single pump source.

2. The difference Δ between (a) the gain change arising in the doped fiber that undergoes the largest gain change and (b) the gain change arising in the doped fiber that undergoes the next largest gain change, should be maximized. This criterion ensures that the change in amplifier performance is as large as possible, making it easier to identify the failed pump.

These two criteria may be applied to a coupling ratio having the form:

aᵢᵢ=a

where a is some numerical value for all i that ensures that more pump energy is distributed from input port i to output port i than from input port i to output port j (i≠j). Since the remaining power that is to be divided among the remaining (N−1) output ports of the coupler must be transmitted through ports having a total coupling ratio of (1−a), the remaining coupling ratios can be selected as follows:

aᵢⱼ=(1−a)/(N−1)

The above two equations do not uniquely determine the value of a. However, appropriate values of a can be selected by applying criteria (1) and (2) as follows:

The remaining pump energy supplied to the doped fibers after pump failure is:

(1−a) (1)

Δ=a−(1−a)/(N−1)=(aN−1)/(N−1) (2)

Criteria (1) and (2) specify that the functions F set forth in equations 1 and 2 should be maximized. These functions and their dependence on the coupling ratio a are shown in FIG. 2.

For the conventional case of equal coupling in which the same amount of power is distributed to all the doped fibers, aᵢⱼ=a=1/N for all i and j. While this maximizes the remaining pump energy supplied to the doped fiber after pump failure (criteria 1), it also gives rise to Δ=0 (criteria 2). At another extreme, where a =1, Δ is maximized, but there is no remaining pump energy available, thus leading to complete failure of an optical amplifier. Evidently, the optimum choice of a to meet the aforementioned criteria lies between 1/N and 1.

Also shown in FIG. 2 (curve 20) is the value of F (denoted Fₒ) that gives rise to the minimum gain change (or minimum change in output power) that can realistically be measured by the monitoring arrangement that is employed to determine the amplifier gain. Accordingly, a value of a should be chosen so that Δ has a value greater than Fₒ. Assuming that the minimum measurable gain change has a value of R (defined as a fraction of 1), the optimal coupling ratio is given by:

a=(1+R(N−1))/N

A numerical example will now be provided. For the N=4 case, with R=0.2, the optimal coupling ratios for the asymmetric coupler are given by:

aᵢⱼ=0.4

a_{ij≠i}=0.2

For this case, if Pump 114₁ fails, then amplifier 112₁ falls to 60%, and amplifiers 112₂, 112₃, 112₄ fall to 80% of their maximum value. Since the monitoring arrangement can resolve a 20% change in gain or output power, it can be easily determined that pump 114₁ has failed since amplifier 112₁ has the lowest gain or output power. Similar reasoning holds for any other pump failure.

Continuing with this numerical example, if after pump 114₁ fails, pump 114₂ fails, the measured performance of amplifiers 112₁, 112₂, 112₃ and 112₄ fall to 40%, 40%, 60%, and 60%, respectively. The failed pumps can be determined from this pattern of gain changes, assuming that the pumps do not fail simultaneously.

1. An optical repeater, comprising:
a plurality of optical amplifiers;
a plurality of pump sources for providing pump energy to the plurality of optical amplifiers; and
a coupling arrangement coupling the pump energy from the plurality of pump sources to the plurality of optical amplifiers so that the pump energy from each pump source is distributed among at least two of the plurality of optical amplifiers in a substantially unequal manner.

2. The optical repeater of claim 1 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between a given one of the input ports and at least two of the output ports.

3. The optical repeater of claim 1 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between each of the plurality of input ports and at least two of the output ports.

4. The optical repeater of claim 1 wherein the coupling arrangement comprises a plurality of input ports respectively coupled to the plurality of pump sources and a plurality of output ports respectively coupled to the optical amplifiers, said coupling arrangement being characterized by a coupling ratio that gives rise to a unique pattern in gain change of the optical amplifiers upon failure of a particular one of the plurality of pump sources.

5. The optical repeater of claim 1 wherein the coupling arrangement comprises a plurality of input ports respectively coupled to the plurality of pump sources and a plurality of output ports respectively coupled to the optical amplifiers, said coupling arrangement being characterized by a coupling ratio between a first of the input ports and a first of the output ports that is greater than the coupling ratio between said first input port and all remaining output ports.

6. The optical repeater of claim 5 wherein said coupling arrangement is further characterized by a coupling ratio between a second of the input ports and a second of the plurality of output ports that is greater than the coupling ratio between said second input port and all remaining output ports.

7. The optical repeater of claim 1 wherein said optical amplifiers are rare-earth doped optical amplifiers.

8. The optical repeater of claim 7 wherein said rare-earth doped optical amplifiers are erbium-doped optical amplifiers.

9. The optical repeater of claim 1 wherein said coupling arrangement is a fused fiber coupler.

10. The optical repeater of claim 1 wherein said plurality of optical amplifiers comprises four optical amplifiers, said plurality of pump sources comprise four pump sources, and said coupling arrangement is a 4×4 coupler.

11. An optical amplifier arrangement, comprising:
a plurality of rare-earth doped fibers each coupled to a different optical transmission path;
a plurality of pump sources for providing pump energy to the plurality of rare-earth doped fibers; and
a coupling arrangement coupling the pump energy from the plurality of pump sources to the plurality of rare-earth doped fibers so that the pump energy from each pump source is distributed among at least two of the plurality of rare-earth doped fibers in a substantially unequal manner.

12. The optical amplifier arrangement of claim 11 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between a given one of the input ports and at least two of the output ports.

13. The optical amplifier arrangement of claim 11 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between each of the plurality of input ports and at least two of the output ports.

14. The optical amplifier arrangement of claim 11 wherein the coupling arrangement comprises a plurality of input ports respectively coupled to the plurality of pump sources and a plurality of output ports respectively coupled to the optical amplifiers, said coupling arrangement being characterized by a coupling ratio that gives rise to a unique pattern in gain change of the optical amplifiers upon failure of a particular one of the plurality of pump sources.

15. The optical amplifier arrangement of claim 11 wherein the coupling arrangement comprises a plurality of input ports respectively coupled to the plurality of pump sources and a plurality of output ports respectively coupled to the optical amplifiers, said coupling arrangement being characterized by a coupling ratio between a first of the input ports and a first of the output ports that is greater than the coupling ratio between said first input port and all remaining output ports.

16. The optical amplifier arrangement of claim 15 wherein said coupling arrangement is further characterized by a coupling ratio between a second of the input ports and a second of the plurality of output ports that is greater than the coupling ratio between said second input port and all remaining output ports.

17. The optical amplifier arrangement of claim 11 wherein said optical amplifiers are rare-earth doped optical amplifiers.

18. The optical amplifier arrangement of claim 17 wherein said rare-earth doped optical amplifiers are erbium-doped optical amplifiers.

19. The optical amplifier arrangement of claim 11 wherein said coupling arrangement is a fused fiber coupler.

20. The optical amplifier arrangement of claim 11 wherein said plurality of optical amplifiers comprises four optical amplifiers, said plurality of pump sources comprise four pump sources, and said coupling arrangement is a 4×4 coupler.

21. A method of distributing pump energy among a plurality of optical amplifiers, said method comprising the steps of:
receiving pump energy from a plurality of pump sources; and
distributing the pump energy from the plurality of pump sources to the plurality of optical amplifiers so that the pump energy from each pump source is provided in unequal amounts among at least two of the plurality of optical amplifiers.

22. The method of claim 21 wherein the step of distributing the pump energy is performed by a coupling arrangement.

23. The method of claim 22 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between a given one of the input ports and at least two of the output ports.

24. The method of claim 22 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between each of the plurality of input ports and at least two of the output ports.

25. The method of claim 22 wherein the coupling arrangement comprises a plurality of input ports respectively coupled to the plurality of pump sources and a plurality of output ports respectively coupled to the optical amplifiers, said coupling arrangement being characterized by a coupling ratio that gives rise to a unique pattern in gain change of the optical amplifiers upon failure of a particular one of the plurality of pump sources.

26. The method of claim 22 wherein the coupling arrangement comprises a plurality of input ports respectively coupled to the plurality of pump sources and a plurality of output ports respectively coupled to the optical amplifiers, said coupling arrangement being characterized by a coupling ratio between a first of the input ports and a first of the output ports that is greater than the coupling ratio between said first input port and all remaining output ports.

27. The method of claim 26 wherein said coupling arrangement is further characterized by a coupling ratio between a second of the input ports and a second of the plurality of output ports that is greater than the coupling ratio between said second input port and all remaining output ports.

28. The method of claim 22 wherein said optical amplifiers are rare-earth doped optical amplifiers.

29. The method of claim 28 wherein said rare-earth doped optical amplifiers are erbium-doped optical amplifiers.

30. The method of claim 22 wherein said coupling arrangement is a fused fiber coupler.

31. The method of claim 22 wherein said plurality of optical amplifiers comprises four optical amplifiers, said plurality of pump sources comprise four pump sources, and said coupling arrangement is a 4×4 coupler.

32. An optical repeater, comprising:
a plurality of optical amplifiers;
a plurality of pump sources for providing pump energy to the plurality of optical amplifiers; and
means, coupling the plurality of pump sources to the plurality of optical amplifiers, for combining the pump energy from the plurality of pump sources and splitting the combined pump energy so that the pump energy from each pump source is distributed among at least two of the plurality of optical amplifiers in a substantially unequal manner.

33. The optical repeater of claim 32 wherein the combining and splitting means comprises a plurality of input ports respectively coupled to the plurality of pump sources and a plurality of output ports respectively coupled to the optical amplifiers, said combining and splitting means being characterized by a coupling ratio that includes at least two different values for optical paths located between a given one of the input ports and at least two of the output ports.

34. The optical repeater of claim 32 wherein the combining and splitting means comprises a plurality of input ports respectively coupled to the plurality of pump sources and a plurality of output ports respectively coupled to the optical amplifiers, said combining and splitting means being characterized by a coupling ratio that includes at least two different values for optical paths located between each of the plurality of input ports and at least two of the output ports.

35. The optical repeater of claim 32 wherein the combining and splitting means comprises a plurality of input ports respectively coupled to the plurality of pump sources and a plurality of output ports respectively coupled to the optical amplifiers, said combining and splitting means being characterized by a coupling ratio that gives rise to a unique pattern in gain change of the optical amplifiers upon failure of a particular one of the plurality of pump sources.

36. The optical repeater of claim 32 wherein the combining and splitting means comprises a plurality of input ports respectively coupled to the plurality of pump sources and a plurality of output ports respectively coupled to the optical amplifiers, said combining and splitting means being characterized by a coupling ratio between a first of the input ports and a first of the output ports that is greater than the coupling ratio between said first input port and all remaining output ports.

37. The optical repeater of claim 36 wherein said combining and splitting means is further characterized by a coupling ratio between a second of the input ports and a second of the plurality of output ports that is greater than the coupling ratio between said second input port and all remaining output ports.

38. The optical repeater of claim 32 wherein said optical amplifiers are rare-earth doped optical amplifiers.

39. The optical repeater of claim 38 wherein said rare-earth doped optical amplifiers are erbium-doped optical amplifiers.

40. The optical repeater of claim 32 wherein said combining and splitting means is a fused fiber coupler.

41. The optical repeater of claim 32 wherein said plurality of optical amplifiers comprises four optical amplifiers, said plurality of pump sources comprise four pump sources, and said combining and splitting means is a 4×4 coupler.

42. A method for identifying a failure of a particular pump source from among a plurality of pump sources that collectively supply pump energy to a plurality of optical amplifiers, said method comprising the steps of:
monitoring a change in an output parameter from each of the plurality of optical amplifiers;
upon failure of a particular one of the plurality of pump sources, identifying a change in the output parameter from each of the plurality of optical amplifiers; and
based on said change in the output parameter from each of the plurality of optical amplifiers, identifying said particular one of the plurality of pump sources that has failed.

43. The method of claim 42 wherein the output parameter is amplifier gain.

44. The method of claim 43 wherein the output parameter is optical output power.

45. The method of claim 42 further comprising the step of distributing the pump energy from the plurality of pump sources to the plurality of optical amplifiers so that the pump energy from each pump source is provided in unequal amounts among at least two of the plurality of optical amplifiers.

46. The method of claim 45 wherein the step of distributing the pump energy is performed by a coupling arrangement.

47. The method of claim 46 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between a given one of the input ports and at least two of the output ports.

48. The method of claim 46 wherein the coupling arrangement comprises a plurality of input ports respectively coupled to the plurality of pump sources and a plurality of output ports respectively coupled to the optical amplifiers, said coupling arrangement being characterized by a coupling ratio that includes at least two different values for optical paths located between each of the plurality of input ports and at least two of the output ports.

49. The method of claim 46 wherein the coupling arrangement comprises a plurality of input ports respectively coupled to the plurality of pump sources and a plurality of output ports respectively coupled to the optical amplifiers, said coupling arrangement being characterized by a coupling ratio that gives rise to a unique pattern in gain change of the optical amplifiers upon failure of a particular one of the plurality of pump sources.

50. The method of claim 46 wherein the coupling arrangement comprises a plurality of input ports respectively coupled to the plurality of pump sources and a plurality of output ports respectively coupled to the optical amplifiers, said coupling arrangement being characterized by a coupling ratio between a first of the input ports and a first of the output ports that is greater than the coupling ratio between said first input port and all remaining output ports.

51. The method of claim 50 wherein said coupling arrangement is further characterized by a coupling ratio between a second of the input ports and a second of the plurality of output ports that is greater than the coupling ratio between said second input port and all remaining output ports.

52. The method of claim 46 wherein said optical amplifiers are rare-earth doped optical amplifiers.

53. The method of claim 52 wherein said rare-earth doped optical amplifiers are erbium-doped optical amplifiers.

54. The method of claim 46 wherein said coupling arrangement is a fused fiber coupler.

55. The method of claim 46 wherein said plurality of optical amplifiers comprises four optical amplifiers, said plurality of pump sources comprise four pump sources, and said coupling arrangement is a 4×4 coupler.
